(19) United States
(12) Patent Application Publication
(10) Pub. No.: US 2014/0032694 A1
(43) Pub. Date: Jan. 30, 2014

(54) TECHNIQUES FOR EVENT NOTIFICATION

(71) Applicants: Steven M. Cohn, Franklin, MA (US); Virginia L. Corbin, Northbridge, MA (US); John Carneiro, Milford, MA (US); Andreas Wintergalen, Pulheim (DE)

(72) Inventors: Steven M. Cohn, Franklin, MA (US); Virginia L. Corbin, Northbridge, MA (US); John Carneiro, Milford, MA (US); Andreas Wintergalen, Pulheim (DE)

(21) Appl. No.: 13/981,119

(22) PCT Filed: Feb. 24, 2012
(86) PCT No.: PCT/US12/26450

§ 371 Date: Oct. 7, 2013

Related U.S. Application Data
(60) Provisional application No. 61/449,135, filed on Mar. 4, 2011.

(51) Int. Cl. H04L 12/00

(52) U.S. Cl. CPC H04L 12/00
USPC 709/207

(57) ABSTRACT

Described are techniques for event notification in a data system. Severity levels associated with event messages with-in the data system are specified. The data system is used to control operation of one or more instruments performing analysis of a sample. Event notification subscription criteria for a user of the data system in specified. Notification are provided to the user regarding a plurality of even occurrences in accordance with the event notification subscription criteria.

### BACKGROUND

1. Technical Field

This application generally relates to computer systems, and more particularly to techniques used in connection with event notification.

2. Description of Related Art

Different scientific instruments may be included in a laboratory. Such scientific instruments may include mass spectrometers (MS), instruments performing a chromatographic separation such as gas chromatographs (GC) and liquid chromatographs (LC), and the like. Operation of such instruments may be controlled using a computer system directly connected to one or more of the instruments. For example, a computer system may be used to control operation of an LC and an MS to obtain mass spectral data for a sample. The computer system may also be used in connection with performing further processing and analysis of the data, such as the mass spectra, acquired using the instruments. The data acquired from the instruments (such as raw data acquired from the instruments prior to subsequent analysis processing) as well as additional data analysis information may be stored on data storage devices of the computer system. Users may log on to the computer system with account names and passwords for authentication. Such authentication may be required prior to allowing a user to operate the instruments and also utilize software on the computer system to perform subsequent data processing and analysis of the data acquired using the instruments.

The foregoing system including the instruments and computer may be used to analyze various products and samples such as, for example, in connection with products developed by pharmaceutical companies and testing samples in hospitals and governmental laboratories. The systems performing this analysis may be regulated and required to be compliant with certain standards, guidelines, and/or regulations covering a wide variety of items. For example, the scientific instruments may be required to comply with government regulations for instrument qualification and validation. The regulations may require access/control restrictions to the instruments and computer system, and may require implementation of computerized techniques to ensure data integrity and security of the computer system as well as data acquired from the instruments and subsequent analysis data.

Management and use of such systems may require that an administrator or other authorized user monitor the instruments and computer systems, for example, to ensure proper functioning and control settings, to ensure that any regulatory requirements are met, to detect any security violations or attempted security violations, and the like. In connection with the foregoing, it may be desirable to utilize an efficient and automated technique which provides for notification of events within such systems.

### SUMMARY OF THE INVENTION

In accordance with one aspect of the invention is a method for event notification in a data system. Severity levels associated with event messages within the data system are specified. The data system is used to control operation of one or more instruments performing analysis of a sample. Event notification subscription criteria for a user of the data system is specified. Notification are provided to the user regarding a plurality of event occurrences in accordance with the event notification subscription criteria. The step of providing notification may include sending event notification messages internally within the data system to the user. The step of providing notification may include providing a notification icon to the user when logged into the data system, said notification icon visually indicating a highest severity level associated with an unread event notification message sent to the user. The notification icon may be associated with any of an audio indicator distinguishing said highest severity level from other severity levels of events and a notification message indicating a total number of read and unread messages sent to the user. Each of the plurality of event occurrences may correspond to an action occurring in connection with any of: one of the instruments controlled by the data system, data managed by the data system, security of the data system, an account of the data system, administration of the data system, creation or modification of a method controlling operating parameters of one of the instruments, creation or modification of a method that performs subsequent analysis of data acquired using one of the instruments, and creation or modification of a calibration curve. The method may also include recording each of the plurality of event occurrences in an event log, said event log including an entry for each of said plurality of event occurrences. The event notification subscription criteria may include one or more categories of event notification messages to which said user is subscribing, and, for each of said one or more categories, may identify one or more of said severity levels. The severity levels may be predefined severity levels including an alert level, a warning level and an information level. The alert level may indicate the highest of the predefined severity levels and the information level may indicate the lowest of the predefined severity levels. The event notification subscription criteria may identify first criteria in connection with event notifications sent to a user internally within the data system and second criteria in connection with event notifications sent to an electronic mail account and system external to the data system. The data system may perform analysis of raw data acquired using the instruments and a first of said plurality of event occurrences may indicate operating a first of said instruments using a first defined method including one or more parameter settings for the instrument to acquire the raw data. A second of said plurality of event occurrences may indicate performing subsequent analysis of the raw data using a second defined method including one or more analysis parameters. A third of said plurality of event occurrences may indicate results of said subsequent analysis. The user may receive three notifications corresponding to the three event occurrences and the three notifications may be received by the user internally within the data system when the user has a logon session with the data system. The three notifications may be associated with a severity level and event category included in the event notification subscription criteria for the user. Each of the one or more instruments may perform any of liquid chromatography and mass spectrometry, supercritical fluid chromatography, capillary electrophoresis, analog to digital signal conversion and/or transmission, and gas chromatography. The highest severity level may be associated with an audio indicator resulting in a sound played when the notification icon reflects the highest severity level. The notification icon may be continually updated and displayed on each displayed user interface while the user is logged into the data system. The method may also include providing an event browser to view events in said event log. The event browser may display the events in the event log in accordance with sorting criteria and filtering criteria. The sorting criteria may include a plurality of sorting levels, each of said sorting levels identifying one of severity level, date, event category, action causing an event, user name identifying a user account of the data system, full user name, and a message describing additional event information. The filtering criteria may include identifying any of: one of a plurality of predefined event categories, one of a plurality of predefined event severities, date information, an action, a user name identifying a user account of the data system, and one or more terms of a message describing additional event information.

The user may display event notifications received in an inbox for the user in accordance with the event notification subscription criteria, wherein the event notification received may be displayed in a view in accordance with selected sorting and filtering criteria. The sorting criteria may include a plurality of sorting levels, each of said sorting levels identifying one of severity level, date, event category, action causing an event, user name identifying a user account of the data system, full user name, and a message describing additional event information. The filtering criteria may include identifying any of: one of a plurality of predefined event categories, one of a plurality of predefined event severities, date information, an action, a user name identifying a user account of the data system, and one or more terms of a message describing additional event information.

In accordance with another aspect of the invention is a system comprising: one or more instruments used to analyze a sample; a data system including a computer readable medium comprising code stored thereon for: controlling operation of the one or more instruments to acquire data; performing subsequent processing of the acquired data of the one or more instruments; specifying severity levels associated with event messages within the data system; specifying event notification subscription criteria for a user of the data system; and providing notifications to the user regarding a plurality of event occurrences in accordance with the event notification subscription criteria; and one or more computer systems, wherein at least one of said computer systems is used to control operation of the one or more instruments and at least one of the computer systems is used by the user of the data system to perform actions using the data system. The data system may have defaults specified in accordance with regulatory requirements. The specifying severity levels may include modifying one or more default severity levels associated with the event messages. The specifying may include modifying at least one severity level for at least one of the event messages to a highest of a plurality of predefined severity levels. Each of the action may correspond to any of setting or modifying parameters of one of the instruments, performing an operation using data acquired with one of the instruments, performing acquisition of data using one of the instruments, performing subsequent analysis of data acquired from one of the instruments, creating or modifying a method used with one of the instruments, and creating or modifying a method for performing subsequent analysis of data acquired from one of the instruments.

In accordance with another aspect of the invention is a computer readable medium comprising code stored thereon for event notification in a data system, the computer readable medium comprising code for: specifying severity levels associated with event messages within the data system, wherein the data system is used to control operation of one or more instruments performing analysis of a sample; specifying event notification subscription criteria for a user of the data system; and providing notifications to the user regarding a plurality of event occurrences in accordance with the event notification subscription criteria.

### BRIEF DESCRIPTION OF THE DRAWINGS

Features and advantages of the present invention will become more apparent from the following detailed description of exemplary embodiments thereof taken in conjunction with the accompanying drawings in which:

FIG. 1 is an example of an embodiment of a system that may utilize the techniques described herein;

FIG. 2 is an example of components that may be included in a client and a server in an embodiment in accordance with techniques herein;

FIG. 3 is an example illustrating information of an event log as may be used in an embodiment in accordance with techniques herein;

FIGS. 4, 5, 6, 6B, 7, 9, 10 and 10B are examples of user interface displays that may be used in an embodiment in accordance with techniques herein;

FIG. 8 is an example illustrating use of event log with the event browser and user subscription criteria in an embodiment in accordance with techniques herein; and

FIG. 11 is a flowchart of processing steps that may be performed in an embodiment in accordance with techniques herein.

### DETAILED DESCRIPTION OF EMBODIMENT(S)

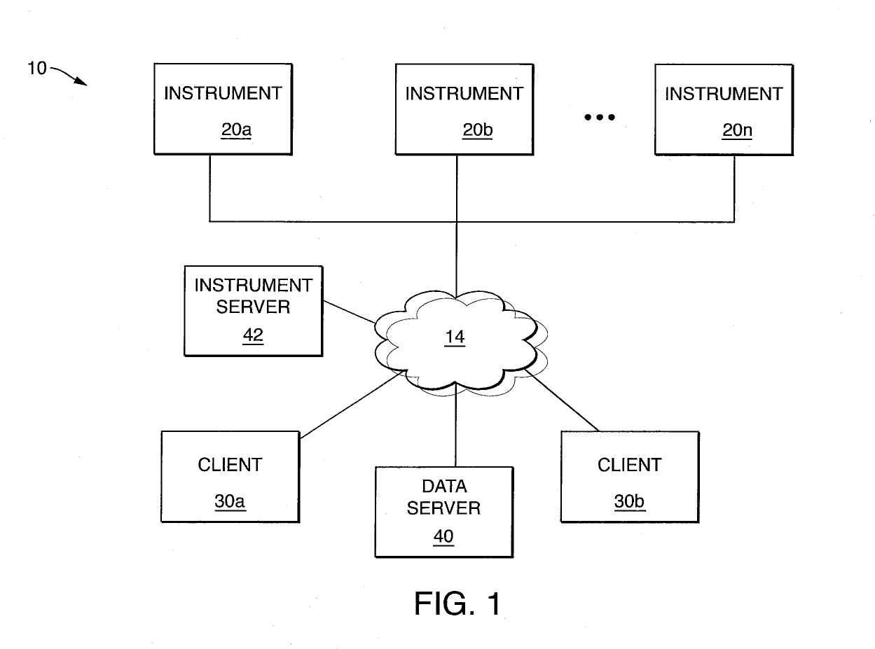

Referring to FIG. 1, shown is an example of an embodiment of a computing environment and system that may be used in performing the techniques described herein. The computing environment illustrated in FIG. 1 is only one example of a suitable computing environment and is not intended to suggest any limitation as to the scope of use or functionality of the techniques described herein. Those skilled in the art will appreciate that the techniques described herein may be suitable for use with other general purpose and specialized purpose computing environments and configurations. Examples of well known computing systems, environments, and/or configurations include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The techniques set forth herein may be described in the general context of computer-executable instructions, such as program modules, executed by one or more computers or other devices. Generally, program modules include routines, programs, objects, components, data structures, and the like, that perform particular tasks or implement particular abstract data types. Typically the functionality of the program modules may be combined or distributed as desired in various embodiments.

Included in FIG. 1 are instruments 20a-20n, client computers 30a, 30b, data server computer 40, instrument server computer 42, and a network 14. Each of the client computers 30a, 30b and server computers 40, 42 may be a standard, commercially-available computer or a special-purpose computer that may be used to execute one or more program modules. Described in more detail elsewhere herein are program modules that may be executed by client computers 30a, 30b and/or server computers 40, 42 in connection with facilitating event notification with respect to events occurring within the system and components of FIG. 1. Such notification may relate to events of any aspect of the system and its components such as, for example, setting and operation of the instruments 20a-20n and servers 40, 42, software applications and data files stored on the data server, administration and security of the accounts user to control logon access to a data system of the data server, and the like. In one embodiment as described in more detail below, the event notification may be provided by software included in a data system used in connection with the instruments 20a-20n for users of the data system. The event notification provided may be characterized as an internal with respect to the data system and may be provided to only users of the data system. For example, an e-mail system external to, or not included in, the data system may be installed on the components of FIG. 1. The data system providing the event notification in accordance with the techniques herein does not replace such email systems and may or may not be integrated with such email systems. The internal event notification with respect to the data system may be provided to users of data system independent of any such external email system.

The computers 30a, 30b, 40 and 42 may operate in a networked environment and communicate with other computers, instruments, and other components not shown in FIG. 1. The instruments 20a-20n may be scientific instruments such as liquid chromatography systems, supercritical fluid chromatography systems, capillary electrophoresis, gas chromatography systems, mass spectrometers, and other instrumentation types which may perform, for example, analog to digital signal conversion and/or transmission which are connected to the network 14 and in communication with the client computers 30a, 30b and server computers 40, 42. The instruments 20a-20n may include, for example, one or more scientific instruments offered by Waters Corporation of Milford, Mass. (or any other supplier).

As will be apparent to those of ordinary skill in the art, the techniques described herein may also be used in an embodiment in which a computer is not connected to a network. For example, a computer system utilizing the techniques herein may be directly connected to one or more instruments rather than through a network. For purposes of illustration, exemplary embodiments may be described which relate to computers used with instruments, such as scientific instruments, but should not be construed as so limited. The foregoing and other aspects and uses of techniques herein are described in more detail in following paragraphs.

The client computers 30a, 30b and server computers 40, 42 may have one or more applications executing thereon for use in connection with the instruments 20a-20n. The event notification techniques herein within the data system may be used in connection with notification related to the instruments integrated for use with the data system as well as security and administration of the computerized systems(s) of the data system (e.g., client and/or server systems and software applications thereon such as a data system described below to facilitate instrument communication, diagnostics, control, and data acquisition that may occur in connection with those instruments). In one embodiment, the data system may be the UNIFI™ system from Waters Corporation of Milford, Mass. The data system may provide functionality to collect, process, and distribute scientific information. With the data system, laboratories are able to automatically capture, secure, access, and disseminate information from any analytical technology. The data system may include functionality for an automated electronic repository that stores and manages all types of scientific data to a centralized database, offering integration with a multitude of research applications. The data system may be used in connection with controlling and managing the instruments, providing security by controlling access to activities within the data system, as well as the data and devices (e.g., instruments and computers) on the system, performing data processing, designing and using methods for data analyses and reporting, and the like. For example, the data system may include a database and may be used to provide a data-secured environment to store and retrieve data in support of regulated laboratories, using an embedded, relational database, acquire data and control a variety of instruments, perform instrument and/or software qualification, validation, and the like. An example of data that may be acquired from one of the instruments 20a-20n, where the instrument is a mass spectrometer, is a series of spectra or scans collected over time. As known in the art, a mass-to-charge spectrum is intensity plotted as a function of m/z. Each element, a single mass-to-charge ratio, of a spectrum may be referred to as a channel. Viewing a single channel over time provides a chromatogram for the corresponding mass-to-charge ratio. The generated mass-to-charge spectra or scans can be acquired and recorded on a storage medium such as a hard-disk drive or other storage media accessible to a computer. Typically, a spectrum or chromatogram is recorded as an array of values and may be stored, for example, in a database of the data system on the data server 40. The spectra stored on the data server 40 may be accessed using one of the client computers 30a, 30b such as for display, subsequent analysis, and the like. Data such as the foregoing may be stored in a data container or repository, such as a relational database or other storage facility, and remotely shared such as by multiple clients. As another example, the data system may be used in connection with providing settings for the instruments 20a-20n. For example, the data system may be used in connection with setting various parameters of a mass spectrometer and liquid chromatography system and ensuring proper access and control in connection with modifying such settings. The instrument server 42 may communicate with the one or more instruments 20a-20n to control the setting and operation of such instruments. A user may access instruments 20-20n or data such as may be stored on the data server 40 by logging onto the data system using one of the clients 30a, 30b. The data server 40 may include software of the data system for controlling access to the system using authentication techniques known in the art such as user account and passwords with one or more roles associated with the user accounts. As a security measure, roles may define types of data access and operations which an associated user is allowed to perform.

Described in following paragraphs are techniques that may be used in connection with providing notification to users of the data system regarding the occurrence of events within the system. The techniques may be used to provide notification of events related to the instruments integrated with the data system, access and control of the instruments, security, data processing functions, administrative and non-data acquisition functionality provided by the data system. For example, an event may be logged when an instrument's parameters are set or modified by a user of the data system, when the instrument controlled by the data system is used to perform data analysis, regarding the results of the analysis, when an instrument integrated with the data system (or component of such an instrument) fails, each time a user logs in/out of the data system, when an authorization or login attempt failure of the data system occurs, when a user of the data system attempts to perform an operation for which the user has inadequate privileges, and the like.

It will be appreciated by those skilled in the art that although components of the system of FIG. 1 are shown in the example as communicating in a networked environment, the components may communicate with each other and/or other components utilizing different communication mediums and may or may not be networked together. For example, the components of FIG. 1 may communicate with each other and/or one or more components utilizing a network connection, and/or other type of link known in the art including, but not limited to, the Internet, an intranet, or other wireless and/or hardwired connection(s). Furthermore, as noted above, the techniques herein may be used in an embodiment with standalone computers connected directly to instruments such as without network connectivity.

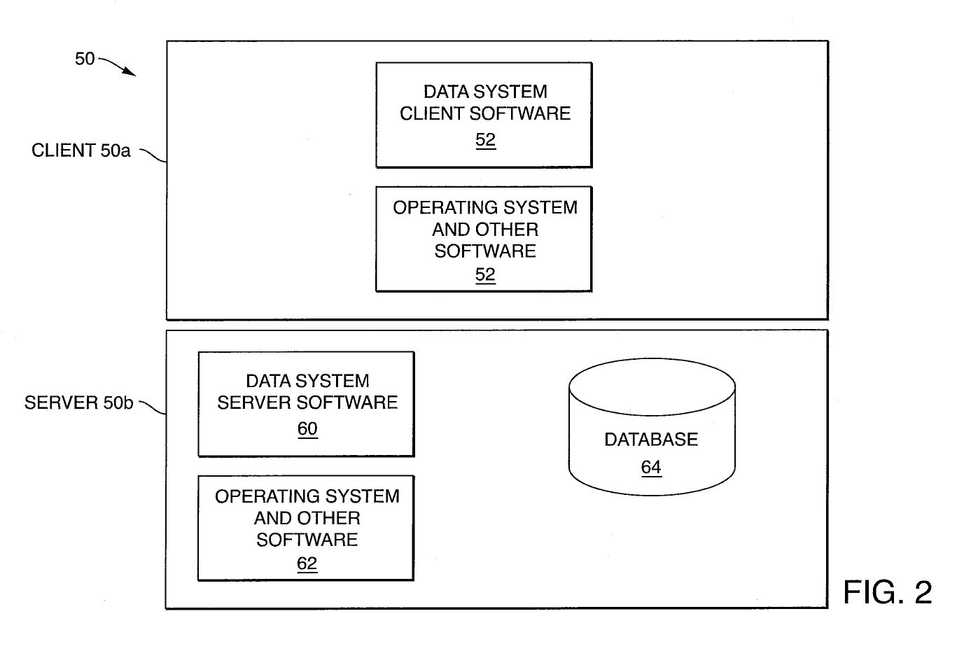

Referring now to FIG. 2, shown is an example of components that may be included in a client computer 20a and data server computer 40 in an embodiment in accordance with techniques herein. The client computer 20a may include data system client software 52 and operating system and other software 56. The data system client software 52 may be, for example, the client portion of the data system described above to control and manage the instruments. In one embodiment, the client may be characterized as a thin client or a fat client. With the thin client, a majority of the application's functionality is performed by software included on the data server 40. In contrast, a thick or fat client is one in which a large portion of the application's functionality is performed by or embodied in the client software 52. The particular partitioning of functions performed by the client and data server may vary with application. Element 56 represents the operating system and possibly other software that may be on the client computer 20a. The operating system may be any one of a variety of commercially available or proprietary operating system such as, for example, a Windows-based operating system by Microsoft Corporation.

The data server 40 may include data system server software 60, a database 64, and operating system and other software 62. Software represented by elements 60 and 64 may be included in the data system. The software 60 may include software implementing the event notification techniques described herein providing internal event notification to users of the data system. This is described in more detail in following paragraphs.

Although not illustrated in FIG. 2, each of the client 20a and data servers 40 may be a computer include one or more processing units, memory, a network interface unit, storage, and the like. Depending on the configuration and type of computer, the memory thereof may be volatile (such as RAM), non-volatile (such as ROM, flash memory, etc.) or some combination of the two. The storage may include removable and/or non-removable storage for use with computer system including, but not limited to, USB devices, magnetic or optical disks, or tape. Such storage devices have associated computer-readable media that may be utilized by the computer and may include, for example, a hard disk or CD-ROM drive, that can be accessed by the computer. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, (DVD) or other optical storage, magnetic cassettes, magnetic tape, magnetic disk storage or other magnetic storage devices, or any other medium which can be used to store the desired information and which can accessed by the computer. Each of the computers may also contain communications connection(s) to facilitate communication with other devices and components such as, by way of example, input devices and output devices. Input devices may include, for example, a keyboard, mouse, pen, voice input device, touch input device, barcode reader, etc. Output device(s) may include, for example, a display, speakers, printer, and the like. These and other devices are well known in the art.

As mentioned above, the data system client software 52 as well as server software 60 and the database 64 may comprise a data system of one or more applications used in connection with the instruments of FIG. 1. For example, such software represented by element 60 may be used to control operations of a liquid chromatography system or mass spectrometer, set instrument parameters used to operate the instruments, collect and store data such as results of analysis performed by the instruments, and the like. The software included in the data system may be used to manage system security of the instruments, securely provide for storing data that is used and generated by the instruments, control access to such data and the actions within the application with respect to users in accordance with roles, permissions, and the like.

The event notification techniques described herein may be used in a regulated as well as a non-regulated system. For example, the techniques herein may be used in connection with a regulated system meeting FDA regulatory requirements such as specified in 21 CFR parts 211, 11, and 58. An embodiment of the data system may provide for user access using accounts and passwords. Each user account may be associated with one or more roles providing different levels of access, operations, and permissions to control the level and/or type of activities for each such user account. For example, there may be a system administrator account for an administrator of the data system. The system administrator may have elevated privileges and permissions to perform required operations, view and/modify data of the system, perform account and data system management, and the like. Another user may be a chemist having appropriate permissions to set instrument parameters, operate an instrument and perform data acquisition and analysis. However, the chemist may have restrictions on administrative functions. For example, the chemist may not have permissions to create and manage user accounts of the data system. In an embodiment of a regulated system, the data system may allow access to authenticated users only and may track all operations performed by each such user when logged into the data system. Each time a user logs in as well as the actions performed by each such user, resulting status of instruments when performing such actions, and the like, may be reflected in events which are logged by the data system. Such event occurrences result in writing corresponding entries to an event log of the data system. The event log may be stored on storage of the data server 40 or other computer system used in connection with the data system. The event notification techniques described herein provide for sending notifications originating from entries of the event log. As described in more detail below, users of the data system may subscribe to selectively receive notification of various event occurrences.

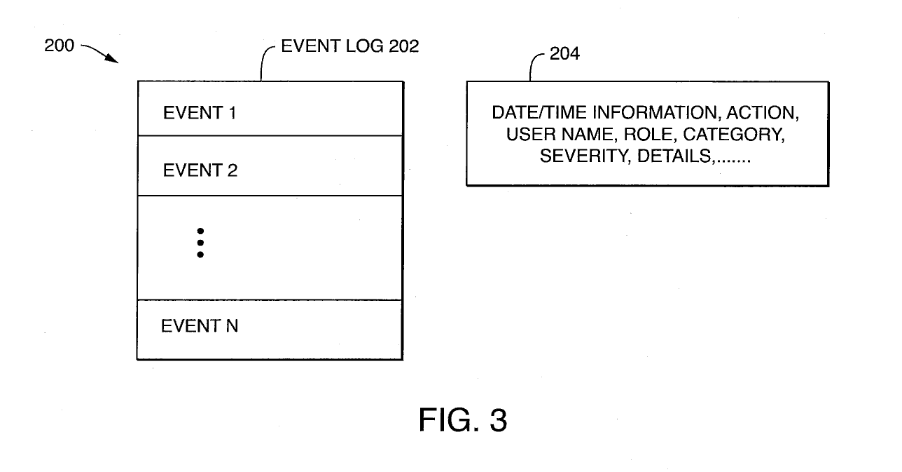

Referring to FIG. 3, shown is an example of an event log as may be used in an embodiment in accordance with techniques herein. The example 200 includes an event log 202 including N entries corresponding to information recorded for N corresponding events. Each entry in the event log 202 may include information such as illustrated by element 204. For example, an entry in the event log may include date and time information regarding when the event occurred, an action (e.g., the action performed triggering the event occurrence) a user name (e.g. such as of a user or account of the data system who performed an action causing the event), role associated with the user (e.g., administrator, chemist), a category (e.g., a predefined event classification for the event), a severity (e.g., a predefined severity level for the event), additional details regarding the event (e.g., as may be included in an event message described elsewhere herein), and the like.

What will now be described are exemplary screenshots as may be displayed on a user interface in connection with a typical workflow of the data system in an embodiment in accordance with techniques herein. For purposes of illustration, the data system and instruments may be included in a regulated system. By default, the data system may ship to customers with appropriate defaults specified in accordance with regulation requirements such as in accordance with FDA or other requirements.

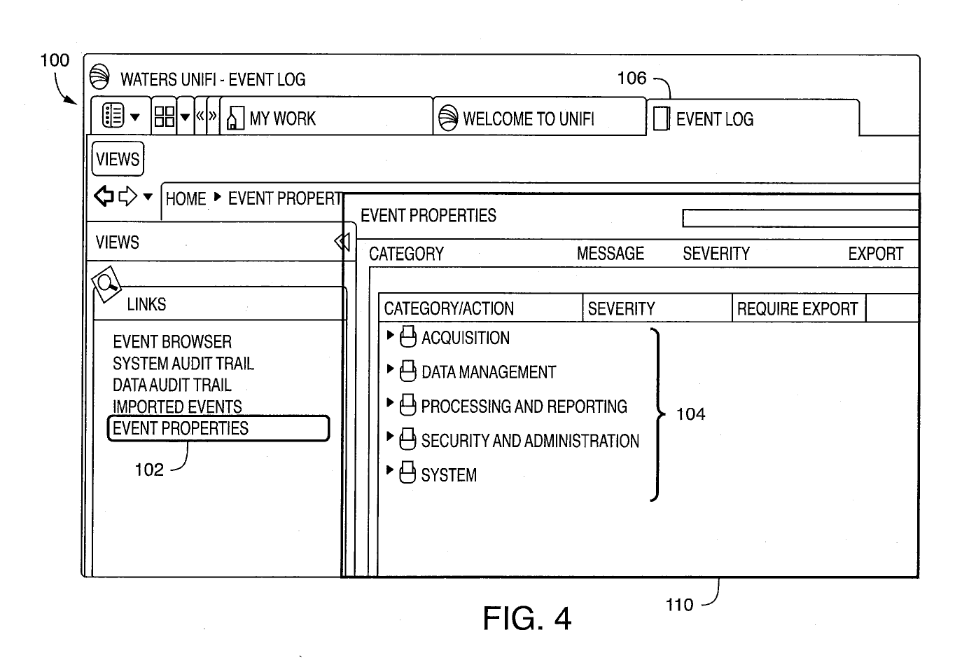

Referring to FIG. 4, shown is an example of a screenshot 100 that may be displayed on a user interface in connection with a system administrator who is logged into the data system in accordance with techniques herein. The example 100 may be used in connection with the administrator setting the severity level of events that may occur in the data system. The administrator may log into the data system and select the tab 106, event log, and then item 102, event properties. In response to selecting event properties 102, the right hand side 110 of the display may be populated with event categories 104. In this example as illustrated by 104, all possible events of the data system may be partitioned into 5 categories—acquisition, data management, processing and reporting, security and administration, and system.

The acquisition category includes events generated by instruments of the system such as, for example instruments 20a-20n of FIG. 1. For example, acquisition events may include notifications regarding state of the instrument (e.g., when the instrument starts, has a component failure, is low on solvent, and the like). The data management category may include events related generally to data management. For example, methods may be defined in a system which describe parameters for instrument operation and control to acquire data and also for subsequent analysis of the acquired data. To further illustrate, a method may be defined in a system which specifies operating parameters for an LC (e.g., which solvent to use, runtime) and/or MS (e.g., kV setting). Furthermore, a method may identify parameters and information used in further analysis of raw data acquired from an instrument. For example, a method may identify a calibration curve used in determining a concentration of a substance in an unknown sample (currently be analyzed) by comparing the unknown to a set of standard samples of known concentration. The curve may indicate how an instrumental response changes (e.g. Y axis values) with respect to different known concentrations of an analyte (e.g., X axis values), or more generally a substance, to be measured. From this curve representing the expected behavior/instrument response measurement, an unknown concentration of the analyte in a sample may be determined. For example, the instrument signal/response may be measured for the analyte in the unknown. Using the calibration curve, interpolation may be used to determine the concentration of the unknown. A user of the data system, such as a chemist, may logon and create or define such methods. The action of creating and/or modifying a method may result in an event occurrence in the data management category. The processing and reporting category may include events related to processing of the data acquired from the instruments and also reporting such as regarding the results of data analysis. The processing and reporting category may include events associated with processing and viewing data and events associated with generating, capturing, approving and printing reports. The processing and reporting category may include, for example, the results of running a defined method to determine a concentration as described above for a sample. As another example, a threshold may be included in a method where the threshold specifies a minimum level of detection. The result of whether a drug having the threshold level is detected in a sample may be indicated by an event occurrence in the processing and reporting category. The security and administration category may include events related to security and administration of the data system. For example, events in the security and administration category may indicate failed logon attempts, when each user logs in, when a user changes his/her password, and operations performed by an administrator with respect to user accounts (e.g., creation, change in permissions/roles). The system category may include events related to other aspects of the system such as when a printer is added, fails, or taken offline.

In connection with an exemplary system herein, the data system may be shipped with defaults including having every event message in all 5 categories set to warning, enabling full audit trail (e.g., causing each action of a user to be logged in the event log), and requiring that all messages be archived prior to deletion. As described below, an event message may be assigned one of three predefined severity levels—informational, warning and alert—with informational being the minimum severity level and alert being the maximum of highest severity level. Full audit trail enabled results in tracking all actions of all users (e.g., recording an entry for each operation or action performed by all users in the event log). An administrator may also indicate whether a message indicating a particular event may be deleted from the event log without first being archived or exported.

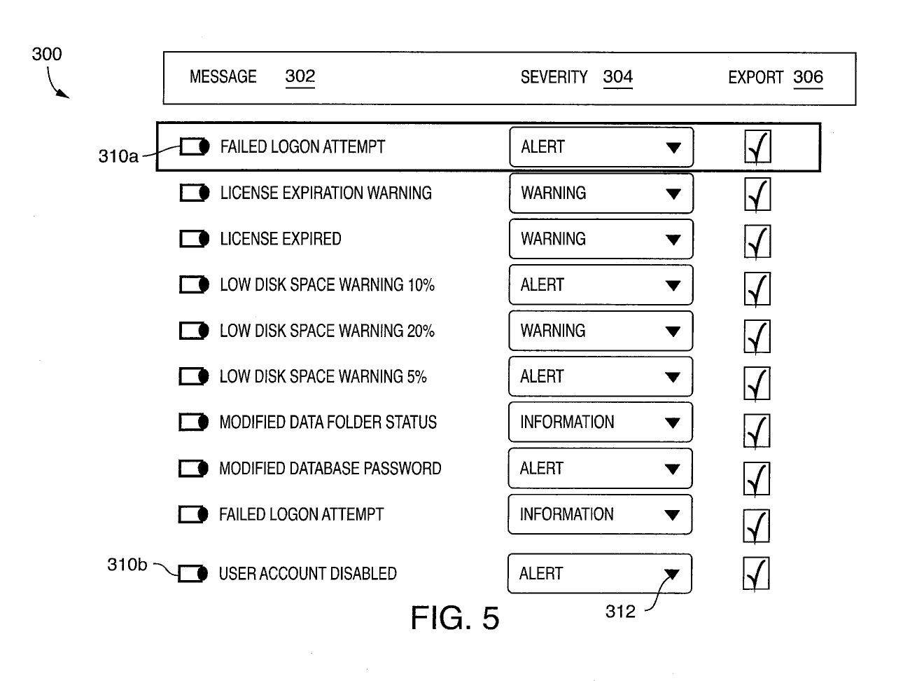

Referring back to FIG. 4, the administrator may select one of the 5 categories included in 104. In response, a list of event messages in that particular selected category may be displayed. For example, referring to FIG. 5, shown is an example of a partial list of event messages that may be displayed in response to selecting the security and administration category from 104 of FIG. 4. Each possible event is indicated by a row of information including a message 302, severity 304 and export indicator 306. The message 302 may indicate the event message text describing the event. The severity 304 indicates the selected severity level associated with the occurrence of the event described by the message text of 302. By default as indicated above, the severity 304 may be set to warning for each event which may be further modified using the displayed interface of FIG. 5. The export indicator 306 indicates whether a message identifying a particular event may be deleted from the event log without first being archived or exported. A checkmark in column 306 indicates that such archival or exportation is required prior to allowing deletion of the associated event message from the event log. For example, element 310a indicates that the event message identifying a “failed login attempt” is set to an alert severity level and requires that entries of the event log be exported or archived prior to deletion. As noted above, the default severity level of all event messages may be set to warning. The severity level of a displayed event message may be modified, such as by a system administrator of a customer site, using the interface of FIG. 5. For example, element 310b may identify an event message for “user account disabled” which occurs when a user exceeds a predefined number of login attempts. The system administrator may modify the severity level for the event message 310b from warning to alert using the interface of FIG. 5. This may be performed by selecting arrow 312 which results in a drop down list of the 3 predefined severity levels (e.g., alert, warning and information). An administrator or other user with appropriate elevated privileges may modify the severity from the default setting of warning to alert as indicated in the example 300 by appropriate selection from the displayed list of severities. In a similar manner, other event properties such as the property 306 may be modified. In this example as noted above, element 306 may be checked (e.g., set to on) for all messages by default and may be modified for one or more event messages by an administrator or other user with appropriate permission by unchecking the box in column 306.

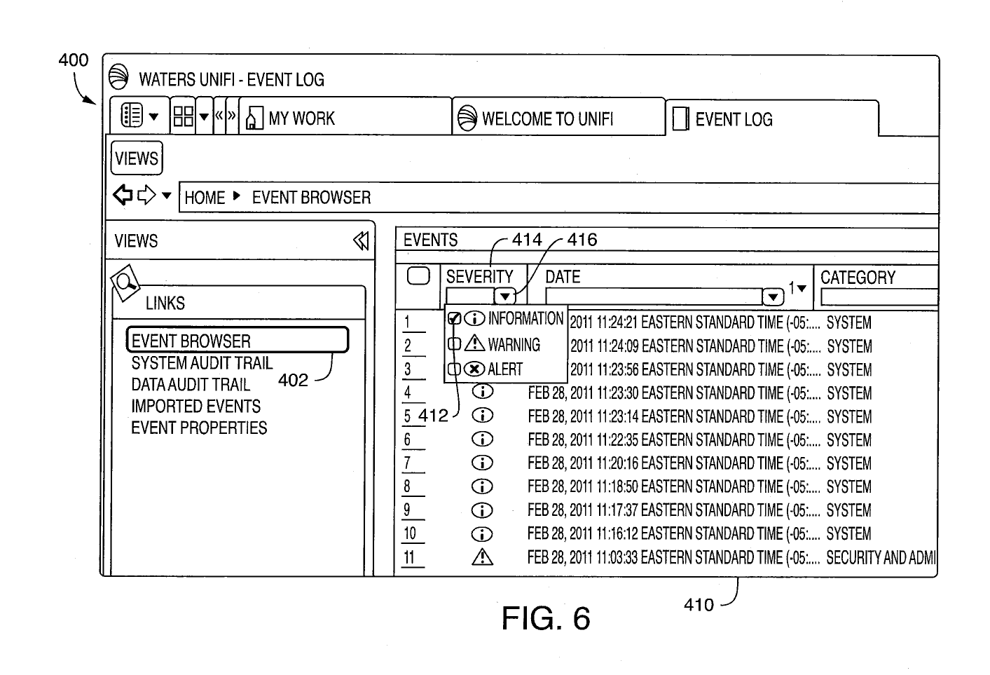

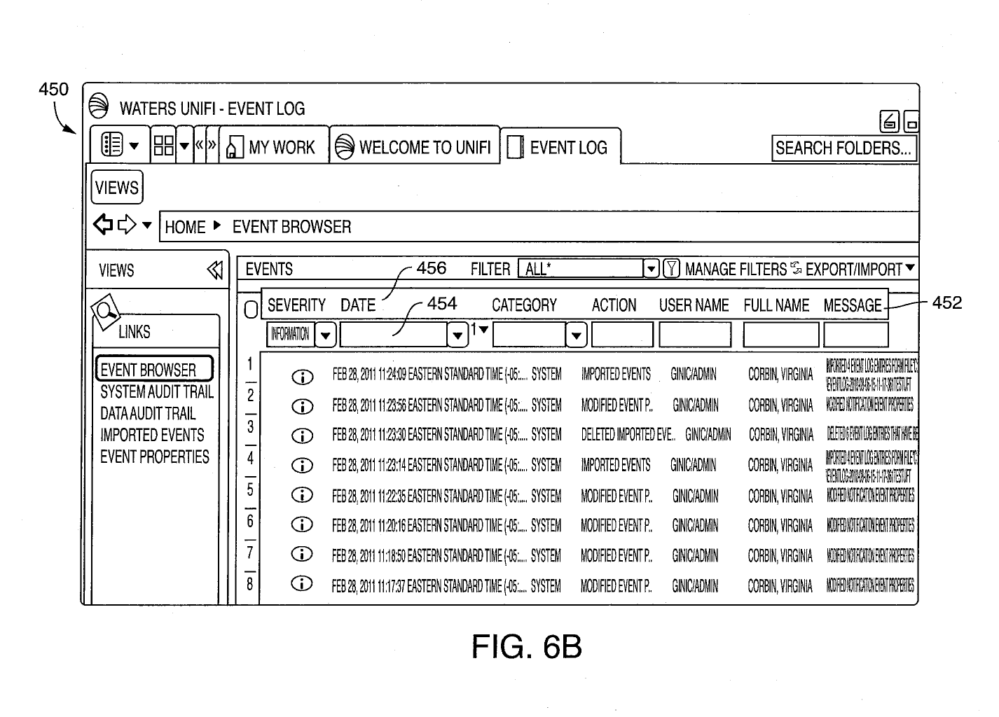

The administrator or other privileged user may be allowed to view all events included in the event log. To perform this operation, with reference to FIG. 6, the administrator may select event browser 402 from the left hand side of the displayed menu and a list of all events currently in the event log may be displayed on the right hand side 410. The administrator may select to view the events in the event log sorted based on severity level by selecting 414. In response the right hand side of the display 410 may be updated to display the events sorted from highest (alert) to lowest (information) severity level. Furthermore, the administrator may apply a severity filter so that only those events of one or more selected severity levels are displayed. For example, selection of arrow 416 may result in a drop down list 412 being displayed from which the user may select one or more severity levels. Those events in the event log having the selected severity level(s) may be displayed in the right hand side 410. In this example, the administrator may select the information severity level (e.g. denoted by the encircled letter “i”). In response, the portion of the display 410 may be updated as further illustrated in FIG. 6B to include only the events of the select information severity level.

Referring to FIG. 6B, shown is the event log viewed with the additional filtering criteria as specified above to include only those notifications of the information severity level. The example 450 also is an enlarged view of the user interface display for the event browser. The administrator may select to sort the event notifications based on any one or more criteria of 452 including severity, date, category, action, user name, fill name and message. By selecting one of the criteria in 452 the messages of the event log may be sorted based on that criteria. For example, by selecting date 456, the displayed information messages may then be sorted based on date. Subsequently then selecting category of 452 uses the category of each event as third tier sorting criteria so that all information severity messages having a same date are further sorted based on category. An embodiment may allow for one or more such sorting level criteria. Entering information in 454 may specify additional criteria for filtering the events in the event log. For example, a particular month or day may be entered in 454 so that only those events having the information severity level and the particular month or day entered are displayed. In a similar manner, an embodiment may allow a user specify additional filtering criteria for any of severity, date, category, action, user name, full name and message. Therefore, a user may sort by the criteria included in 452 and may also specify terms for each of the criteria in 452 which further filter or limit the displayed event notifications.

Each user of the data system may be allowed to subscribe to receive selected notifications of interest rather than all notifications of all event occurrences in the data system.

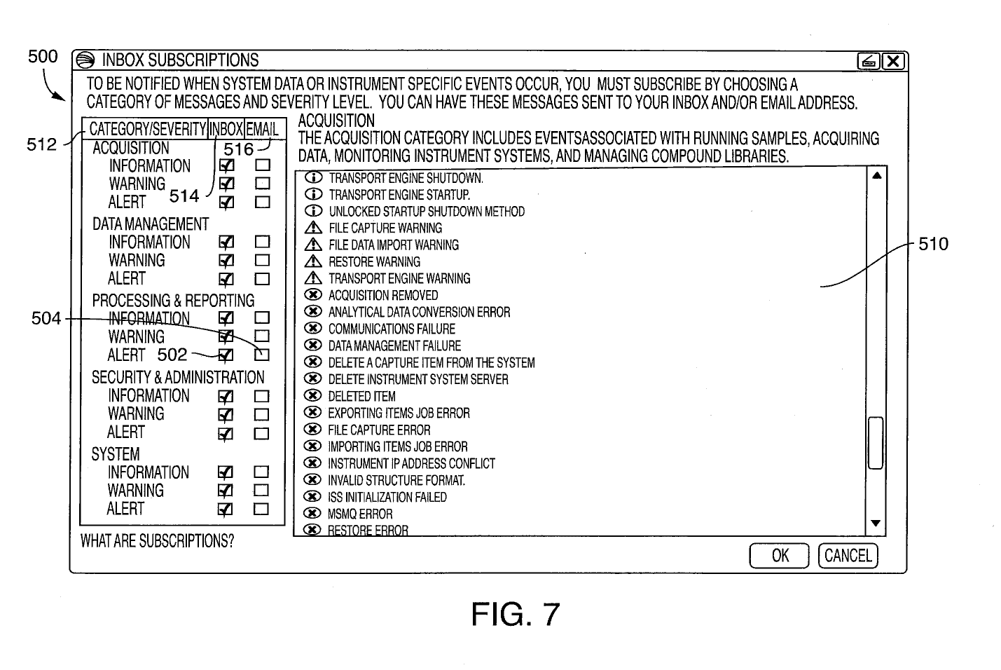

Referring to FIG. 7, shown is an example of a screenshot that may be displayed in connection with a user subscribing to receive selected event notifications. The example 500 lists subscription criteria on the left side of the display and includes the possible categories and severities 512 to which a user can subscribe. Additionally, the user may select to receive the event notifications in the user's data system inbox 514 and/or an email account 516. In this example, the data system has its own internal message inbox for each user/account. By viewing messages in the user's inbox, the event notifications meeting the user's subscription criteria may be displayed. The data system may also provide the user with an option of having the event notifications sent to a separate external email account for the user. The inbox indicated by column 514 refers to the inbox of the data system providing internal notification within the data system to users of the data system. The user may also elect to have event notifications sent to an external email application by selecting the appropriate boxes in column 516 email. In the example 500, the user has selected all entries of column 514 and subscribes to receive in the user's inbox of the data system notifications for all severity levels of all categories. The user has not selected to have such notifications sent to an external email account and system (e.g., no boxes in column 516 are checked). However, as a variation to the foregoing, in addition to having all entries in column 514 checked, the user may also select 504 to have the event notifications of the processing and reporting category having the alert severity level also sent to an external email system and account for the user. The particular email account may be specified using another interface (not illustrated). Element 510 illustrates the event notification messages in the Acquisition category.

In one embodiment, the system may provide the user with subscription options to send event notifications only to the inbox of the data system, only to the external email account, or both the external email account and inbox of the data system. Furthermore, an embodiment may also provide subscription options allowing the user to select to have a first set of notifications sent to the user's external email account and a second different set of notifications sent to the inbox. For example, in the example 500, the user may initially select to have all messages of all severity levels and all categories sent to the inbox of the data system (by selecting all entries in column 514). At a later point in time, the user may deselect option 502 (so that processing and reporting alert messages are not sent to the user's inbox of the data system) and the user may also select to have processing and reporting alert level event messages (by selecting 504) sent to only the user's external email account and not the user's inbox of the data system. It should be noted that an embodiment may also implement a variation of the foregoing. For example, an embodiment may provide a user with options to send event notifications to the inbox or both the inbox and external email account where the user may not have the option of sending notifications only to an email account without having them also sent to the inbox.

In this example 500, the user is allowed to subscribe to notifications per category and also, within each category, by severity level. It should be noted that event occurrences of particular categories may be of importance to a regulated customer and system such as operating in accordance with FDA compliance. For example, in connection with the exemplary five categories noted above, the data management category and the processing and reporting category may be associated with event occurrences of particular interest in the regulated analytical instrument laboratory as described herein. The occurrence of particular events, particular sequence of events, or repetitive occurrence of particular events may indicate fraud, impermissible data manipulation, or activities comprising the data and/or system integrity. For example, events in the processing and reporting category may occur when a calibration curve is created or modified, when an instrument fails qualification, and when an instrument passes qualification. A sequence of event occurrences in the event log may indicate repeatedly having an instrument fail qualification following by modification of the calibration curve. After a number of such occurrences, the instrument may then pass qualification. The foregoing may indicate a fraudulent attempt of a user to qualify an instrument. By having the system administrator appropriately set the severity level of particular events to alert (such as described above in connection with FIGS. 4 and 5) and having a user such as the system administrator subscribe to receive selected notification of events of interest (e.g., such as for a particular category and severity level of interest), the administrator may be notified of events of interest. The user, such as an administrator, may then examine the reported events of interest to determine if another user is performing inappropriate activities, if there are security issues which need attention, and the like.

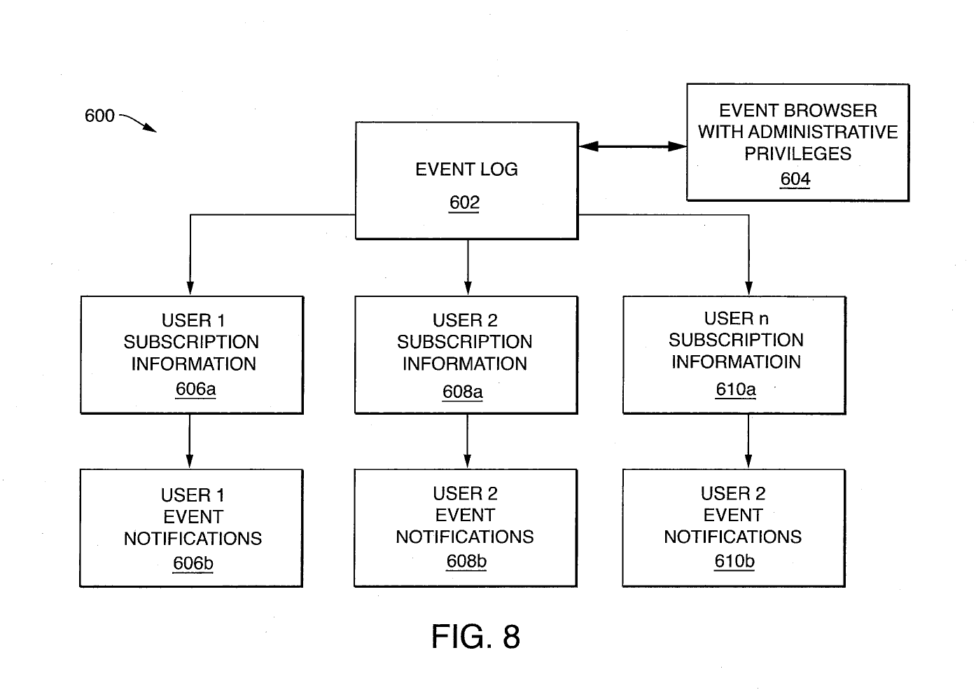

Referring to FIG. 8, shown is an example further illustrating use of subscription information in connection with the event log in an embodiment in accordance with techniques herein. The example 600 includes event log 602. The event log 602 may be viewed 604 using the event browser with administrative privileges such as illustrated in connection with FIGS. 6 and 6B. Three users of the system—user 1, user 2 and user 3—may each specify subscription information such as illustrated in connection with FIG. 7. Element 606a represents subscription information for user 1. Element 606b represents those selected events of the event log 602 to which user 1 subscribes as may be displayed when viewing notifications in user l's inbox of the data system. The subscription information 606a may be characterized as a subscription filter applied to the event log 602 so that user 1 is only notified of those event messages of interest (as indicated by 606a). Similar to element 606a, elements 608a and 610a, respectively, represent subscription information for user 2 and user 3. Similar to element 606b, elements 608b and 610b, respectively, represent those selected events of the event log 602 to which user 2 and user 3 subscribe.

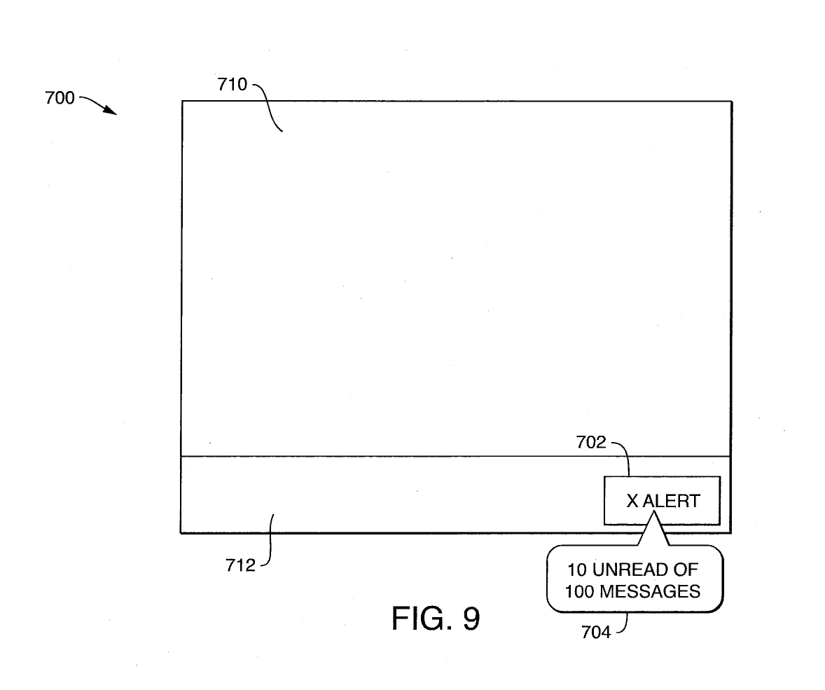

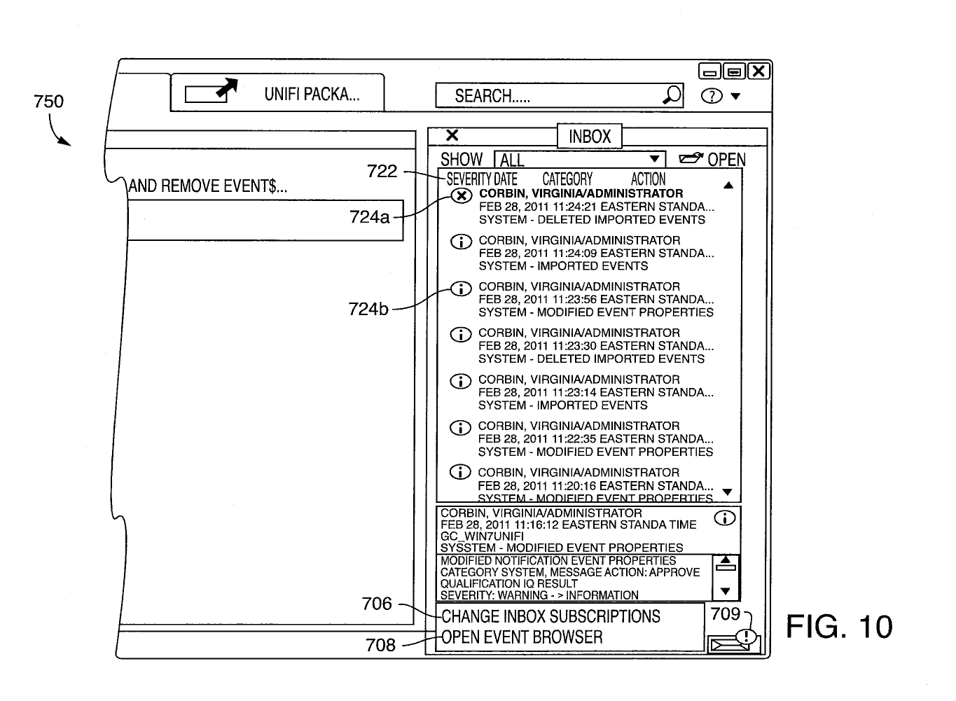

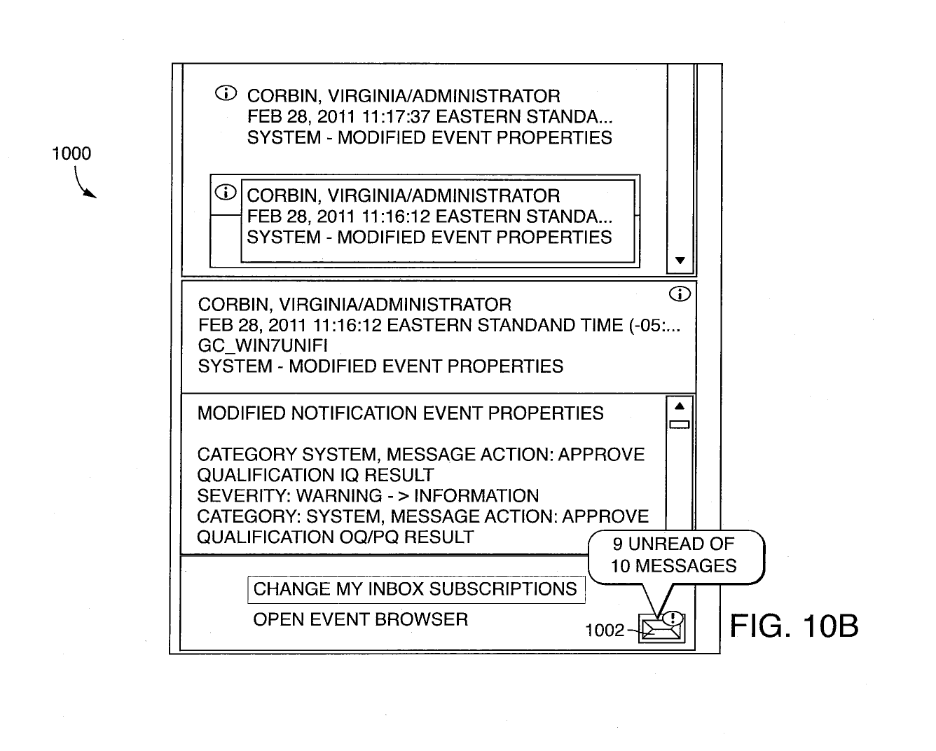

Referring to FIG. 9, shown is an example illustrating use of an event notification icon in an embodiment in accordance with techniques herein. The example 700 includes an upper area 710 and a lower area 712. Area 710 may denote other information that may be displayed in connection with current user selections and operations. Area 712 may include an event notification icon 702 and message 704 that may be included in each user interface displayed in the data system. The event notification icon 702 and message 704 may be updated in accordance with what notifications are currently in the user's inbox of the data system. The icon 702 may have a display based on the highest event severity level for which the user currently has an unread notification message. In the example illustration of FIG. 9, the user's inbox currently has at least one unread event notification message of the highest alert severity level. The message 704 may indicate the total number of unread and read messages in the user's inbox of the data system. Both 702 and 704 may be continually updated as subsequent event notifications for the user are received in the user's inbox of the data system. Based on the icon 702, the user of the data system may also be notified of the highest level of severity of unread event messages to which the user subscribes. In this manner, the user may be performing other operations and activities based on the current display in area 710 and the user may know at a glance when an urgent notification, such as an alert level, is received. For example, at a first point in time, the administrator user may be perform account management and have no unread alert severity notifications in her inbox. While performing account management using menus displayed in area 710, several alert severity notifications may be received in the administrator's notification inbox and the icon 702 may be accordingly updated. In response, the administrator may select the icon 702 and may be connected to the user's inbox such as illustrated in FIG. 10.

FIG. 10 is an example illustrating event notification messages that may be displayed in a user's inbox in connection with the user's previously specified subscription information. For example, if the user subscribed to receive event notifications as indicated in FIG. 7, the inbox of FIG. 10 may display those particular event notifications. In this example, only alert and information severity level messages have been received. As indicated by 709, the alert severity is the highest severity level notification currently unread in the user's inbox. Each message in the inbox may also include a visual indicator of the severity level associated with that message. The alert severity level for a message may be denoted by the “X” visual indicator associated with a message (e.g., such as illustrated by 724a) and the information severity level for a message may be denoted by the encircled “i” visual indicator associated with a message (such as illustrated by 724b). If the message in the inbox had a warning severity level in accordance with the user's subscription criteria, yet another different visual indicator may be displayed and associated with such a warning notification to visually distinguish the warning, alert and information messages. For example, with reference back to element 412 of FIG. 6, an exclamation point (!) within a triangle may be the visual indicator denoting warning severity notification messages. In connection with the example 750, the user may subsequently select to sort the notification messages in the user's inbox by selecting one or more sorting criteria from 722. For example, the user may sort by severity, date, category and/or action. The user may specify one or more levels of sorting criteria. For example, the user may select to view or sort inbox messages based on a first or primary key such as severity, and within severity by date (e.g., using date as a secondary sorting key), and for each date, based on action or category (e.g., using action or category as the third key). Based on the foregoing, the inbox notification messages may be first grouped by severity. For each severity level, the group of messages may then be sorted by date. For each set of messages having a same severity and date, the messages may then be sorted by action or category. An embodiment may allow any number of such sorting or viewing criteria. It should be noted that the sorting criteria and levels described in connection with FIG. 10 may be similar to that as described in connection with FIG. 6B. An embodiment may include the sorting criteria as illustrated in FIG. 10 and also additional sorting criteria (such as related to user name, full name, and message) described in connection with FIG. 6B. Furthermore, an embodiment may also provide support for use of filtering criteria as described in connection with FIG. 6B for use with a user's inbox of FIG. 10.

Referring back to FIG. 9, the event notification icon 702 is illustrated in the bottom lower right portion of every displayed user interface. In this manner, the user may always be provided with updated notification regarding the occurrence of events to which the user has subscribed. It should be noted that the icon 702 and associated message 704 may be in a different location of every displayed user interface than the lower right portion as illustrated in FIG. 9. The icon 702 may have a distinct visual indicator for each of the different severity levels of event notifications. Each of the icon visual indicators for a severity level may be differentiated from other icon visual indicators, for example, using different graphical or text displays, different visual effects (e.g., bold, and/or color), and other techniques. When the icon 702 is updated to reflect a particular severity level, an audio or sound indicator may also be utilized. For example when the icon 702 is updated to reflect an alert severity level, a sound associated with the alert severity level such as a siren, continual beeping, and the like, may be generated. The audio indicator may be result in a sound being projected through speakers of the user's computer, assuming the computer is so enabled. Different audio indicators may be used in connection with differentiating different severity event message severity levels. Additionally, the visual and/or auditory indicator associated with the icon 702 and also the message 704 may be customized such as via user configurable options. For example, the message 704 may indicate the total number of unread and read messages for the user's inbox or a number of read and unread messages of one or more particular categories and/or severity level(s) in the inbox (e.g, only alert level messages, only alert and warning messages of one or more particular categories). Similarly, the user may be provided with the option to customize both the visual and audio indicators associated with the icon 702 (e.g., selecting which image and effects are visually displayed and/or heard for each severity level).

Referring to FIG. 10B, shown is an example 1000 illustrating an enlarged view of the lower right portion of a user interface screen display including the event notification icon as described in connection with FIG. 9. In the example 1000, the event notification icon 1002 indicates that the user currently has a highest event notification level of the warning severity level as indicated by the exclamation point of 1002.

In connection with an administrator which is notified regarding the occurrence of particular events, the administrator may choose to view all events in the event log rather than those in the administrator's inbox. Referring back to FIG. 10, the administrator may connect from her inbox to the event browser by selecting 708. In response, the display may be updated to display all events in the event log in a manner similar to that as illustrated in FIGS. 6 and 6B. Also, referring back to FIG. 10, a user may select to change her inbox subscriptions by selecting option 706. In response to selecting 706, the user may be presented with a display such as illustrated in connection with FIG. 7.

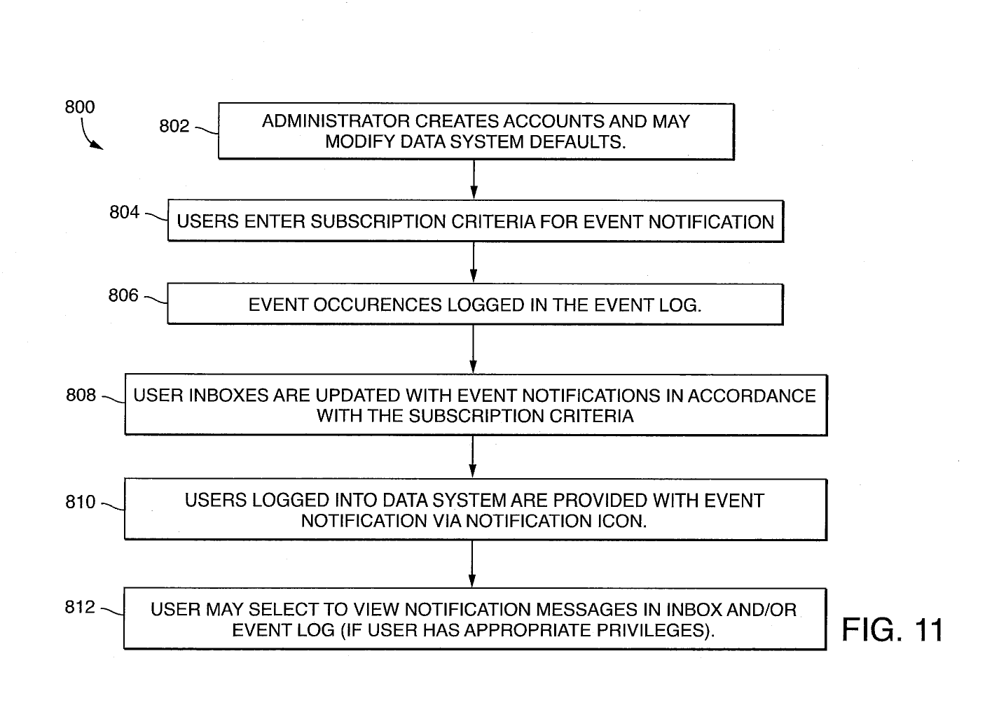

Referring to FIG. 11, shown is a flowchart of processing steps that may be performed in an embodiment in accordance with techniques herein. The flowchart 800 of FIG. 11 summarizes workflow steps that may be performed in an embodiment as described above. At step 802, an administrator of the data system creates user accounts and may also modify data system defaults. For example, the administrator may modify the default event properties such as severity level for one or more events as described in connection with FIGS. 4 and 5. At step 804, a user of the data system may enter subscription criteria identifying those events of interest to the user. As a result, at a later point in time, the user receives notification regarding the occurrence of any events which meet the user's subscription criteria. The user may specify subscription criteria as described above in connection with FIG. 7. At a later point in time as the data system, instruments and computers connected to the data system, and the like, are used, event occurrences are logged in the event log in step 806. As described above, a system may track and log all actions of all users due to the full audit trail being on/enabled. In step 808, each user inbox of the data system is updated with event notifications in accordance with the subscription criteria for the user. At step 810, users logged into the data system may be provided with current up-to-date event notification via the notification icon such as illustrated in connection with FIG. 9. At step 812, the user may select to view the notification messages in the user's inbox (such as described above in connection with FIGS. 9 and 10) and/or the user may select to view the event log if the user has appropriate privileges (such as described above in connection with FIGS. 6 and 6B). It should be noted that the steps 806, 808 and 810 may be repetitively performed with the occurrence of additional events in the data system. Additionally, if a user specifies subscription criteria for notification to an external email account/system, step 808 may include sending such notifications.

Described above are techniques that may be included in a data system for event notification to users of the data system. Such notifications originate from messages included in the event log and may be sent to individual user inboxes within the data system in accordance with user specified subscription criteria. The foregoing inbox may be internal to the data system and may be used alone, or in combination with, an external email account/system.

Using the techniques herein, a user of a data system may be provided with selective notification of events of interest. For example, a system administrator may customize severity levels associated with event messages and may set to the alert level those events which are of particular importance in a system. The system administrator and/or other users may then select to subscribe to those event messages by category and severity level which are of interest to the particular user. Using the techniques herein with the icon indicator of FIG. 9, a user may receive an updated status regarding the highest level of severity of event occurrence. The user may then be able to drill down received event message notifications in the user inbox by using sorting and/or filtering criteria to adjust the user's inbox view of received notifications. Similarly, an administrator or other user with appropriate privileges may select to view all event occurrence by viewing the event log such as illustrated in FIGS. 6 and 6B.

It should also be noted that embodiments are described herein with data systems and scientific instruments such as may be used in connection with sample analysis. More generally, the techniques herein may be used in embodiments with any type of instrument or other device, as well as in connection with other software systems.

The techniques herein may be performed by executing code which is stored on any one or more different forms of computer-readable media. Computer-readable media may include different forms of volatile (e.g., RAM) and non-volatile (e.g., ROM, flash memory, magnetic or optical disks, or tape) storage which may be removable or non-removable.

While the invention has been disclosed in connection with preferred embodiments shown and described in detail, their modifications and improvements thereon will become readily apparent to those skilled in the art. Accordingly, the spirit and scope of the present invention should be limited only by the following claims.

What is claimed is:

1. A method for event notification in a data system comprising:
specifying severity levels associated with event messages within the data system, wherein the data system is used to control operation of one or more instruments performing analysis of a sample;
specifying event notification subscription criteria for a user of the data system; and
providing notifications to the user regarding a plurality of event occurrences in accordance with the event notification subscription criteria.

2. The method of claim 1, wherein said providing notification includes sending event notification messages internally within the data system to the user.

3. The method of claim 1, wherein said providing notification includes providing a notification icon to the user when logged into the data system, said notification icon visually indicating a highest severity level associated with an unread event notification message sent to the user.

4. The method of claim 1, wherein said notification icon is associated with any of an audio indicator distinguishing said highest severity level from other severity levels of events and a notification message indicating a total number of read and unread messages sent to the user.

5. The method of claim 1, wherein each of said plurality of event occurrences corresponds to an action occurring in connection with any of: one of the instruments controlled by the data system, data managed by the data system, security of the data system, an account of the data system, administration of the data system, creation or modification of a method controlling operating parameters of one of the instruments, creation or modification of a method that performs subsequent analysis of data acquired using one of the instruments, and creation or modification of a calibration curve.

6. The method of claim 1, further comprising:
recording each of the plurality of event occurrences in an event log, said event log including an entry for each of said plurality of event occurrences.

7. The method of claim 1, wherein the event notification subscription criteria includes one or more categories of event notification messages to which said user is subscribing, and, for each of said one or more categories, identifying one or more of said severity levels.

8. The method of claim 7, wherein said severity levels are predefined severity levels including an alert level, a warning level and an information level, said alert level indicating the highest of the predefined severity levels and the information level indicating the lowest of the predefined severity levels.

9. The method of claim 7, wherein the event notification subscription criteria identifies first criteria in connection with event notifications sent to a user internally within the data system and second criteria in connection with event notifications sent to an electronic mail account and system external to the data system.

10. The method of claim 1, wherein the data system performs analysis of raw data acquired using the instruments and a first of said plurality of event occurrences indicates operating a first of said instruments using a first defined method including one or more parameter settings for the instrument to acquire the raw data, a second of said plurality of event occurrences indicates performing subsequent analysis of the raw data using a second defined method including one or more analysis parameters, and a third of said plurality of event occurrences indicates results of said subsequent analysis, the user receiving three notifications corresponding to the three event occurrences, said three notifications being received by the user internally within the data system when the user has a logon session with the data system, said three notifications being associated with a severity level and event category included in the event notification subscription criteria for the user.

11. The method of claim 1, wherein each of the one or more instruments performs any of liquid chromatography and mass spectrometry, supercritical fluid chromatography, capillary electrophoresis, analog to digital signal conversion and/or transmission, and gas chromatography.

12. The method of claim 3, wherein the highest severity level is associated with an audio indicator resulting in a sound played when the notification icon reflects the highest severity level.

13. The method of claim 3, wherein the notification icon is continually updated and displayed on each displayed user interface while the user is logged into the data system.

14. The method of claim 6, further comprising:
providing an event browser to view events in said event log.

15. The method of claim 14, wherein the event browser displays the events in the event log in accordance with sorting criteria and filtering criteria.

16. The method of claim 15, wherein said sorting criteria includes a plurality of sorting levels, each of said sorting levels identifying one of severity level, date, event category, action causing an event, user name identifying a user account of the data system, full user name, and a message describing additional event information.

17. The method of claim 15, wherein the filtering criteria includes identifying any of: one of a plurality of predefined event categories, one of a plurality of predefined event severities, date information, an action, a user name identifying a user account of the data system, and one or more terms of a message describing additional event information.

18. The method of claim 1, wherein the user displays event notifications received in an inbox for the user in accordance with the event notification subscription criteria, wherein the event notification received are displayed in a view in accordance with selected sorting and filtering criteria.

19. The method of claim 18, wherein said sorting criteria includes a plurality of sorting levels, each of said sorting levels identifying one of severity level, date, event category, action causing an event, user name identifying a user account of the data system, full user name, and a message describing additional event information.

20. The method of claim 18, wherein the filtering criteria includes identifying any of: one of a plurality of predefined event categories, one of a plurality of predefined event severities, date information, an action, a user name identifying a user account of the data system, and one or more terms of a message describing additional event information.

21. A system comprising:
one or more instruments used to analyze a sample;
a data system including a computer readable medium comprising code stored thereon for:
controlling operation of the one or more instruments to acquire data;
performing subsequent processing of the acquired data of the one or more instruments;
specifying severity levels associated with event messages within the data system;
specifying event notification subscription criteria for a user of the data system; and
providing notifications to the user regarding a plurality of event occurrences in accordance with the event notification subscription criteria; and
one or more computer systems, wherein at least one of said computer systems is used to control operation of the one or more instruments and at least one of the computer systems is used by the user of the data system to perform actions using the data system.

22. The system of claim 21, wherein the data system has defaults specified in accordance with regulatory requirements.

23. The system of claim 22, wherein said specifying severity levels includes modifying one or more default severity levels associated with the event messages.

24. The system of claim 23, wherein said specifying includes modifying at least one severity level for at least one of the event messages to a highest of a plurality of predefined severity levels.

25. The system of claim 21, wherein each of said actions corresponds to any of setting or modifying parameters of one of the instruments, performing an operation using data acquired with one of the instruments, performing acquisition of data using one of the instruments, performing subsequent analysis of data acquired from one of the instruments, creating or modifying a method used with one of the instruments, and creating or modifying a method for performing subsequent analysis of data acquired from one of the instruments.

26. A computer readable medium comprising code stored thereon for event notification in a data system, the computer readable medium comprising code for:
specifying severity levels associated with event messages within the data system, wherein the data system is used to control operation of one or more instruments performing analysis of a sample;
specifying event notification subscription criteria for a user of the data system; and
providing notifications to the user regarding a plurality of event occurrences in accordance with the event notification subscription criteria.
